(19) United States
(12) Patent Application Publication
(10) Pub. No.: US 2025/0185080 A1
(43) Pub. Date: Jun. 5, 2025

(54) PRACH DETECTION IN A WIRELESS NETWORK

(71) Applicant: Intel Corporation, Santa Clara, CA (US)

(72) Inventors: Zhangsheng XU, Shanghai (CN); Lisen ZHU, Beijing (CN); Xiaowen ZHANG, Shanghai (CN); Yuwen LIU, Beijing (CN)

(21) Appl. No.: 18/393,815

(22) Filed: Dec. 22, 2023

(30) Foreign Application Priority Data
Nov. 30, 2023 (WO) PCT/CN2023/135477

(51) Int. Cl. H04W 74/0833; H04J 13/00; H04W 56/00

(52) U.S. Cl. CPC H04W 74/0858; H04J 13/0062; H04W 56/0045

(57) ABSTRACT

The present disclosure relates to a device including: a processor and a memory to: carry out a PRACH detection in a plurality of detection windows, each including a plurality of samples, wherein the PRACH detection includes, for each detection window: comparing a power value of each sample with a predefined threshold power; and after having carried out the comparison for all the samples: if the power value of at least one sample is greater than the predefined threshold power, identifying the sample having the greatest power value, and generating a result signal indicative of a successful PRACH detection and of a position of the identified sample; if all the samples have a power value less than the predefined threshold power, refraining from searching the sample having the greatest power value. The predefined threshold power may include a plurality of threshold powers, to enable communication via a plurality of communication paths.

### CROSS-REFERENCE TO RELATED APPLICATION

The application claims the benefit of International Application No. PCT/CN2023/135477 filed Nov. 30, 2023, which is incorporated by reference herein in its entirety.

### TECHNICAL FIELD

The present disclosure relates to a device for physical random access channel (PRACH) detection in a wireless network, and to methods thereof, e.g. a method of performing PRACH detection in a wireless network.

### BACKGROUND

In general, various technologies and standards have been developed for wireless communication, which is at the basis of a variety of services and applications in everyday life, such as the consumption of entertainment content via streaming services, the implementation of automated driving functionalities via exchange of information with a road infrastructure, or the design of Internet of Things environments in an industrial setting or in a home setting, as examples. Software and hardware components of wireless networks are continuously evolving to satisfy the ever increasing number of connected users, and to ensure a fast and efficient transfer of information to and from the users. An important aspect of the operation of a wireless network is the so-called random access procedure, in particular for establishing an initial connection between a user device and a network device. For example, the random access procedure enables a synchronization between a user equipment and a base station, e.g. both in uplink and downlink, thus allowing the user equipment to adjust the timing of future communications to the base station. The development of advanced strategies for random access procedure in a wireless network is thus of great importance for improving the overall performance of wireless communications.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows an exemplary wireless network in a schematic representation according to the present disclosure;

FIG. 1B shows an exemplary wireless communication device in a schematic representation according to the present disclosure;

FIG. 1C shows an exemplary network access node in a schematic representation according to the present disclosure;

FIG. 2A shows an exemplary PRACH procedure in a schematic representation according to the present disclosure;

FIG. 2B and FIG. 2C show an exemplary PRACH detection in a schematic representation according to the present disclosure;

FIG. 3A shows an exemplary device for performing PRACH detection in a wireless network, in a schematic representation according to the present disclosure;

FIG. 3B shows a plurality of detection windows, in a schematic representation according to the present disclosure;

FIG. 3C shows a schematic flow diagram of a PRACH detection in a wireless network, according to the present disclosure;

FIG. 4A shows a schematic flow diagram of multi-threshold PRACH detection in a wireless network, according to the present disclosure;

FIG. 4B shows a detection window including multiple peaks compared to a plurality of thresholds, according to the present disclosure; and

FIG. 5A and FIG. 5B show graphs comparing a performance of a legacy PRACH detection with the PRACH detection of the present disclosure.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a device for use in a wireless network, a network access node, a wireless communication device, etc.). However, it may be understood that aspects described in connection with methods may similarly apply to the devices, and vice versa.

New generation wireless communication systems provide high data rate, lower latency and improved system performances. With the ever increasing number of users of communication systems, techniques that allow a rapid and robust management of the access of the users to the network are of utmost importance for the development and distribution of reliable and efficient communication systems.

In this context, PRACH (Physical Random Access Channel) plays a relevant role in a wireless communication system (e.g., 3G, 4G, 5G, and the like) in the establishment of an initial connection between a user and the network, illustratively an initial connection between a user device (a user equipment, UE) and a network device (e.g., a base station, Node B, evolved Node B, and the like). Whenever the user device wishes to access the network, for example after powering up or after a period of inactivity, the user device attempts a PRACH procedure to establish contact with the network device. The PRACH procedure allows achieving a synchronization between the user device and the network device for future communications, and allows the user device to obtain resources for the so-called “Message 3”, e.g. a RRC connection request, for connecting with the network device.

In this regard, the term “PRACH” may be used to describe the physical-layer channel, whereas the term “RACH” is the corresponding transport-layer channel. It is understood that the aspects described herein in relation to a “PRACH procedure” may apply in a corresponding manner to a “RACH procedure”, and vice versa.

In general, the procedure with which a network device becomes aware of the reception of a PRACH signal may be time- and resource-consuming, as the network device parses through a plurality of PARCH detection windows, searches for the signal having the maximum peak power within each detection window, and determines that a PRACH signal has been received if the peak power of the signal is greater than a predefined threshold. This procedure requires thus the network device to carry out a time- and resource-consuming search.

The present disclosure is related to an adapted approach to PRACH detection capable of reducing the time at the network-side to determine whether a PRACH signal has been received. Furthermore, the proposed approach exploits the possibility of having more than one communication path between the user device and the network device, thus extending the possibilities of establishing a connection between the user device and the network device compared to a conventional “single path” configuration.

The approach proposed herein may be based on the realization that in PRACH detection, considering practical scenarios, it is rare for all detection windows to have valid signals, and in most cases a detection window includes just noise. The proposed approach may thus be based on determining whether any possible candidate signal exist within a detection window before carrying out the search for the maximum peak power within the window. When considering the computational complexity required for PRACH detection, comparing data with a fixed number saves computational resources more than finding the maximum value and record its position in a pile of data. By utilizing the characteristics of PRACH detection data, reducing the operation of finding the maximum value and its position will reduce the computational workload.

On the contrary, a conventional PRACH detection (also referred to herein as “legacy PRACH detection”) is based on finding the peak power and its position in each window. The legacy PRACH detection thus includes a detection of a plurality of windows (e.g., 64 windows) and finding the maximum value and its position in each window. If the maximum value is greater than the threshold, it is considered that a valid signal has been detected and the position is recorded and reported. The search for the maximum value leads to an increased workload compared to the strategy proposed herein.

As a further aspect, legacy methods of PRACH detection only detect the maximum peak power in each detection window. For a multi-path channel, the legacy approach only uses signal power on strongest path for PRACH detection. The present disclosure provides an approach that exploits the power on more communication paths between the user device and the network device, thus providing additional margin in these channels. Compared with the legacy method, the threshold is lower thus allowing to detect more paths and combine their power, while allowing to distinguish noise and valid multi-path correctly, without causing a high rate of false alarms.

The present disclosure relates to a device configured to perform PRACH detection in a wireless network and to a (computer-implemented) method of performing PRACH detection in a wireless network. In general, the proposed approach may include comparing a power value of each sample of a detection window with a predefined threshold power, and, after having carried out the comparing for all the samples, determining whether to carry out a search for a maximum power within the detection window based on a result of the comparison.

The present disclosure relates to a device for use in a wireless network, the device including: a processor; and a memory configured to store instructions. The instructions, when executed by the processor, cause the processor to: carry out a PRACH detection in a plurality of detection windows. Each detection window includes a plurality of samples, and the PRACH detection includes, for each detection window: comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

The present disclosure relates to a method of PRACH detection, the method including: for each detection window of a plurality of detection windows, with each detection window including a plurality of samples, comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

The proposed approach includes thus an adjusted order of finding the maximum value and comparing data with the threshold in PRACH detection to reduce computational resource consumption compared to legacy approaches. The proposed configuration may accelerate detection speed by avoiding detecting pure noise windows, thus saving computational effort.

In various aspects, a multi-path channel may be considered. Illustratively, a legacy method only uses the strongest path to detect PRACH (illustratively, using the absolute maximum within a detection window). The approach proposed herein may rather utilize the power on more communication paths to improve the performance in terms of missed detection in a multi-path channel.

According to various aspects, the predefined threshold power may include a plurality of threshold powers, e.g. a first threshold power, a second threshold power, a third threshold power, etc. The threshold powers may be different from each other, e.g. the first threshold power may have the greatest power value, the second threshold power may be less than the first threshold power, the third threshold power may be less than the second threshold power, etc. Illustratively, in some aspects, the PRACH detection may include comparing the power of the samples in a detection window with a plurality of threshold powers ordered in descending order with respect to power value.

In this configuration, the PRACH detection may include, for each detection window: comparing the power value of each sample of the plurality of samples within the detection window with the first threshold power and if the power value of at least one sample is greater than the first threshold power, identifying the sample having the greatest power value among the plurality of samples, and generating a result signal indicative of a successful PRACH detection and of a position of the identified sample within the detection window; if all the samples of the plurality of samples have a power value less than the first threshold power, comparing the power value of each sample of the plurality of samples within the detection window with the second threshold power and if the power value of at least two samples are greater than the second threshold power, identifying the samples having power value greater than the second threshold power, and generating a result signal indicative of a successful PRACH detection and of a position of the identified samples within the detection window. The procedure may be repeated for a third threshold power if not enough samples have a power value greater than the second threshold power, and may be further repeated for a fourth threshold power, etc.

The multi-threshold approach allows thus identifying multiple communication paths that combined provide sufficient power to define a successful PRACH procedure and to establish a connection between a user device and a network device. Compared to a conventional “single path approach”, the multi-path configuration increases the number of scenarios in which the PRACH procedure may be successfully completed, thus providing a more flexible approach.

The term “wireless network” as used herein, e.g. in reference to a communication network such as a mobile communication network, encompasses both an access section of a network (e.g., a radio access network (RAN) section) and a core section of a network (e.g., a core network section). A wireless network may provide communication and other types of services to one or more wireless communication devices, e.g. through network access nodes. A wireless network may be or may include a communication network in which the final communication link (e.g., to a wireless communication device) is wireless, e.g. over an air interface. In a given location one or more wireless networks may be deployed, each supporting a radio access technology (RAT) and operating in a respective frequency range. A “wireless network” may also be referred to herein as “radio communication network” or “wireless system”.

The term “network access node” as used herein refers to a network-side device that provides an access network (e.g., a radio access network). A “network access node” may allow wireless communication devices to connect and exchange information with a core network and/or external data networks through the network access node. A “network access node” may thus be or include any device that may be configured to allow a wireless communication device to access a wireless network. A “network access node” may provide coverage for a macro cell, a micro cell, a pico cell, a femto cell, and/or another type of cell of the wireless network. A “network access node” may include any type of base station or access point, including macro base stations, micro base stations, NodeBs, evolved NodeBs (eNBs), New Radio NodeBs (gNBs), Home base stations, Remote Radio Heads (RRHs), relay points, Wi-Fi/WLAN Access Points (APs), Bluetooth master devices, dedicated short-range communication roadside units (DSRC RSUs), wireless communication devices acting as network access nodes, multi-standard radio (MSR) equipment, and any other electronic device capable of network-side wireless communications, including both immobile and mobile devices (e.g., vehicular network access nodes, moving cells, and other movable network access nodes). A network access node may include any suitable combination of hardware and/or software to perform the tasks, features, functions and methods disclosed herein. A “network access node” may also be referred to herein as “RAN node”, or simply as “network node” or “network device”.

The term “wireless communication device” as used herein refers to user-side devices (both portable and fixed) that may connect to a core network and/or external data networks via an access network, e.g. through a network access node. A “wireless communication device” may be configured to communicate wirelessly with other wireless communication devices and/or with a network access node of a wireless network. A wireless communication device may communicate with a network access node via downlink and uplink. “Downlink” may describe the communication link from the network access node to the wireless communication device, and “uplink” may describe the communication link from the wireless communication device to the network access node.

A “wireless communication device” may be or may include any mobile or immobile wireless communication device, including User Equipment (UEs), Mobile Stations (MSs), Stations (STAs), cellular phones, gaming consoles, tablets, laptops, personal computers, wearables, multimedia playback and other handheld or body-mounted electronic devices, consumer/home/office/commercial appliances (e.g., a smart television, a smart refrigerator, etc., in an Internet of Things implementation), vehicles (e.g., a car, or a drone), a robot, and any other electronic device capable of user-side wireless communications. Without loss of generality, in some cases wireless communication devices may also include application-layer components, such as application processors or other general processing components that are directed to functionality other than wireless communications. A wireless communication device may optionally support wired communications in addition to wireless communications. Furthermore, wireless communication devices may include vehicular communication devices that function as wireless communication devices. Certain communication devices may act both as wireless communication devices and network access nodes, such as a wireless communication device that provides network connectivity for other wireless communication devices. A “wireless communication device” may also be referred to herein as “terminal device” (to indicate that the wireless communication device represents the end terminal of a wireless connection), or simply as “wireless device” or “user device”.

The term “user” may be used herein in general to indicate a user of a wireless network, e.g. to indicate a “user of a wireless communication device” or to indicate a wireless communication device itself communicating or attempting to communicate with the wireless network. Illustratively, a “user” in the context of a wireless network may be understood as an entity that may access the wireless network and communicate via the wireless network. A “user” may be, for example, a person, e.g. the owner of a mobile phone, a smartphone, a tablet, etc. A user may however also be a technological entity, e.g. a wireless communication device itself, for example a robot, a smart sensor, a vehicle, etc. that may access the wireless network and communicate via the wireless network independently of the presence of a human operating or otherwise controlling the technological entity.

In the context of the present disclosure it is understood that references to a wireless network and to PRACH detection may refer to a real-world scenario, i.e. to a wireless network existing in the real-world (illustratively, in the physical world) and to PRACH detection to allow real-world users to connect with the real-world network. It is however understood that, in principle, the PRACH detection described herein could also apply to a virtual-world wireless network, illustratively to perform PRACH detection for virtual users in a virtual environment. A virtual-world wireless network may for example be or include a computer-implemented simulation of a wireless network, in which the components and the interactions of the virtual wireless network are computer-simulated to represent the corresponding real-world components and interactions of a corresponding real-world wireless network. A virtual-world wireless network may be part of a simulation, a video game, or a virtual reality implementation, as examples.

In the present disclosure, various aspects are described with terminology that may pertain to particular radio communication technologies, e.g. with terminology that may pertain to the 5G context. It is however understood that the aspects described herein may correspondingly apply to other radio communication technologies, in which same (e.g., structurally same and/or functionally same) components, structures, operations, logic entities, etc. may be referred to with other terms pertaining to the other radio communication technologies.

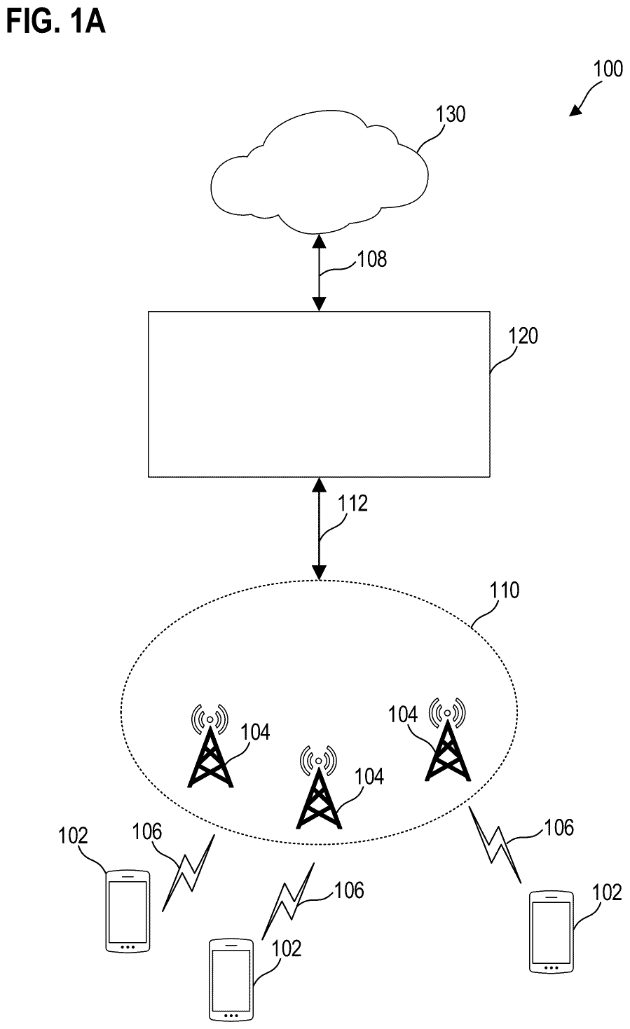

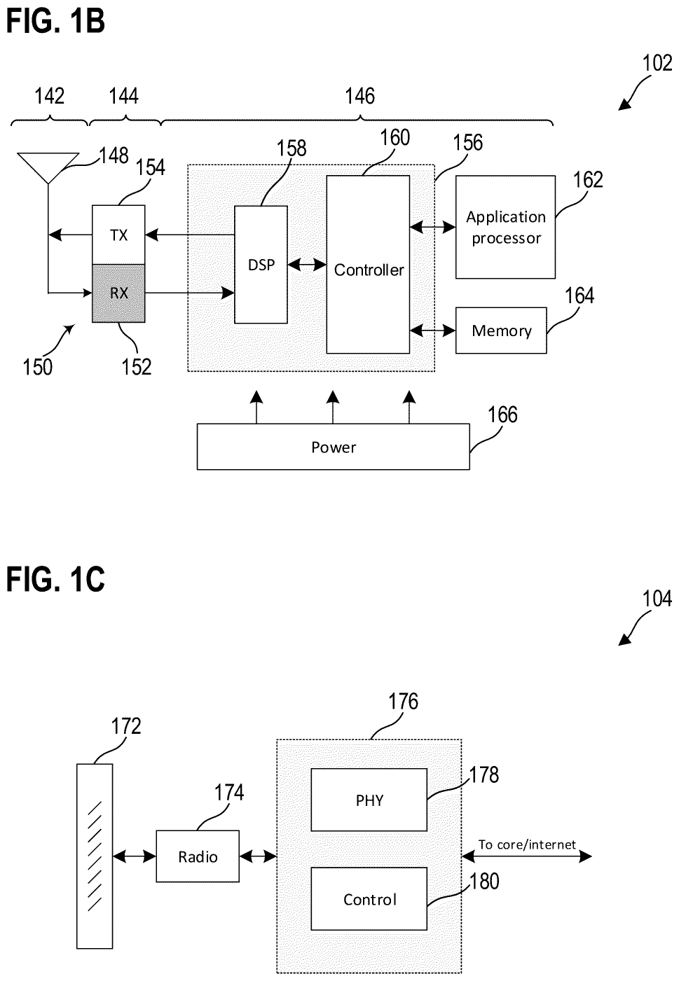

FIG. 1A shows a wireless network 100 in a schematic representation according to the present disclosure. The wireless network 100 may communicate with one or more wireless communication devices 102 via one or more network access nodes 104, e.g. over a physical interface 106 (e.g., an air interface). It is understood that the number of network access nodes 104 and wireless communication devices 102 in wireless network 100 is exemplary and is scalable to any amount.

The wireless network 100 may communicate with the one or more wireless communication devices 102 via various mechanisms. In an exemplary configuration, the wireless network 100 may be an ad-hoc network, which may be self-organizing, i.e., the ad-hoc network may be composed of devices that are not pre-configured to have certain roles. Any device may independently become part of wireless network 100, such as via self-configuration and/or registration with other devices. The ad-hoc network may include heterogeneous devices or homogenous devices. Homogeneous devices may all have the same properties, such as computational power, communication rate, communication technologies, etc. Heterogeneous devices on the other hand, may have varying properties.

In the following, the wireless network 100 will be described with particular reference to the cellular context. It is however understood that the description of the wireless network 100 may correspondingly apply to other configurations of the wireless network, e.g. in the case that the wireless network 100 is or includes a sound wave access network (with communication based on sound waves), or an optical access network (with communication based on visible or non-visible light). Furthermore, in the following some configurations of the wireless network 100 may be described in relation to particular radio access network contexts (e.g., 5G); it is however understood that the description of the wireless network 100 may correspondingly apply to other contexts and other types or configurations of a (radio) access network.

Considering the cellular context, the one or more wireless communication devices 102 may be or may include cellular terminal devices (e.g., Mobile Stations (MSs), User Equipment (UEs), or any type of cellular terminal device). The one or more network access nodes 104 may be or may include base stations (e.g., eNodeBs, NodeBs, gNodeBs, Base Transceiver Stations (BTSs), or any other type of base station). The one or more network access nodes 104 may be part of an access network 110 (e.g., a radio access network) of the wireless network 100. The access network 110 may be, for example, an Evolved Universal Mobile Telecommunications System (UMTS) Terrestrial Radio Access Network (E-UTRAN), a NextGen RAN (NG RAN), an O-RAN, a virtual RAN (vRAN), or some other type of RAN. The wireless network 100 may be a heterogeneous network including network access nodes 104 of different types, such as macro base stations, micro base stations, pico base stations, femto bases stations, etc. Considering an exemplary short-range context, as an alternative, the one or more network access nodes 104 may be or may include access points (APs, e.g., WLAN or WiFi APs), while the one or more wireless communication devices 102 may be or may include short range terminal devices (e.g., stations, STAs). In the short-range context, the one or more network access nodes 104 may interface (e.g., via an internal or external router) with one or more external data networks.

In accordance with some radio communication network technologies, the one or more wireless communication devices 102 may execute mobility procedures to connect to, disconnect from, and switch between available network access nodes 104 of the access network 110. Wireless communication devices 102 may be configured to select and re-select between the available network access nodes 104 in order to maintain a strong radio access connection with the access network 110.

Considering the cellular context, the wireless network 100 may further include a core network 120, with which the one or more network access nodes 104 may interface, e.g. via backhaul interfaces. The core network 120 may be or may include an Evolved Packet Core (EPC, for LTE), Core Network (CN, for UMTS), 5G core network (5GC), as examples, or other cellular core networks. The core network 120 may interface with one or more external data networks 130, e.g. via a suitable interface 108 (e.g., a N6 interface). The core network 120 may provide switching, routing, and transmission, for traffic data related to wireless communication devices 102, and may further provide access to various internal data networks (e.g., control nodes, routing nodes that transfer information between other wireless communication devices on wireless network 100, etc.) and external data networks 130 (e.g., data networks providing voice, text, multimedia (audio, video, image), and other Internet and application data). As an example, the one or more external data networks 130 may include one or more packet data networks, PDNs. A wireless communication device 102 may thus establish a data connection with external data networks 130 via a network access node 104 and core network 120 for data transfer and routing.

The access network 110 and core network 120 may be governed by communication protocols that can vary depending on the specifics of wireless network 100. Such communication protocols may define the scheduling, formatting, and routing of both user and control data traffic through wireless network 100, which includes the transmission and reception of such data through both the radio access and core network domains of wireless network 100. Accordingly, wireless communication devices 102 and network access nodes 104 may follow the defined communication protocols to transmit and receive data over the radio access network domain of wireless network 100, while the core network 120 may follow the defined communication protocols to route data within and outside of the core network 120. Exemplary communication protocols include LTE, UMTS, GSM, WiMAX, Bluetooth, WiFi, mmWave, etc., any of which may be applicable to wireless network 100.

Illustratively, the one or more network access nodes 104 (and, optionally, other network access nodes of wireless network 100 not explicitly shown in FIG. 1A) may accordingly provide a (radio) access network 110 to wireless communication devices 102 (and, optionally, other wireless communication devices of wireless network 100 not explicitly shown in FIG. 1A). In an exemplary cellular context, the (radio) access network that the one or more network access nodes 104 provide may enable the one or more wireless communication devices 102 to wirelessly access the core network 120 via radio communications.

The core network 120 may include one or more core network nodes (not shown in FIG. 1A) configured to implement various functionalities associated with the core network 120, depending on the radio communication technology context. As examples, the core network 120 may include one or more of: a network interface, a broadcast multicast service center (BM-SC), a mobility management entity (MME), a packet data network (PDN) gateway, a visitor location register (VLR), a multimedia broadcast multicast service (MBMS) gateway, a gateway mobile switching center (GMSC), an access and mobility management function (AMF), a session management function (SMF), a user plane function (UPF), a policy control function (PCF), a signaling gateway (SGW), a unified data management (UDM), a network slice selection function (NSSF), an authentication server function (AUSF), an application function, and/or the like.

The one or more network access nodes 104 may be configured to perform various functions of the access network 110, such as uplink and downlink management, data packet scheduling, radio network controller, ciphering and deciphering, handover, synchronization, and/or the like. The one or more network access nodes 104 may be communicatively coupled to the core network 120 via a suitable interface 112, e.g. a S1 interface (for example including a S1-U interface and a serving gateway, S-GW). The one or more network access nodes 104 may communicate with each other, e.g. directly or indirectly, via wired or wireless communication links.

In an exemplary configuration, the access network 110 may be configured according to the Open Radio Access Network or Open RAN concept, e.g. the access network 110 may be or may include an ORAN (also referred to herein as O-RAN). Illustratively, in this exemplary configuration the access network 110 may include non-proprietary hardware and software components, based on open interfaces and standards.

In the following, in relation to FIG. 1B and FIG. 1C, exemplary configurations of a wireless communication device and a network access node will be described. In general, the configuration of a wireless communication device and/or a network access node for wireless communications may be known in the art. A brief description is provided herein to introduce a context for the present disclosure.

FIG. 1B shows a wireless communication device 102 in a schematic representation according to the present disclosure. In general, a wireless communication device 102 may include an antenna system 142 (also referred to herein as antenna circuitry), transceiver system 144 (also referred to herein as transceiver circuitry), and a processing system 146 (also referred to herein as signal processing circuitry). In the following, a description of exemplary components for the various sections 142, 144, 146 of the wireless communication device 102 will be provided.

It is understood that the configuration illustrated in FIG. 1B is exemplary, and a wireless communication device 102 may include additional, less, or alternative components with respect to those shown. As examples, the wireless communication device 102 may include one or more additional hardware and/or software components depending on its configuration and its intended use, such as processors/microprocessors, controllers/microcontrollers, other specialty or generic hardware/processors/circuits, peripheral device(s), power supply, external device interface(s), subscriber identity module(s) (SIMs), user input/output devices (display(s), keypad(s), touchscreen(s), speaker(s), external button(s), camera(s), microphone(s), etc.), or other related components.

Wireless communication device 102 may be configured to transmit and receive radio frequency signals via the antenna system 142, which may include one or more directional or omnidirectional antennas 148, e.g. a single antenna 148 or an antenna array that includes multiple antennas 148. The one or more antennas 148 may include, for example, dipole antennas, monopole antennas, patch antennas, loop antennas, microstrip antennas, or other types of antennas suitable for transmission of radio frequency signals. As an exemplary configuration, an antenna 148 may have multiple apertures, each of which may be considered as an antenna. In an exemplary configuration, the antenna system 142 may additionally include analog antenna combination and/or beamforming circuitry.

Transceiver system 144 may include a radio frequency (RF) transceiver 150, having a receive (RX) path 152 and a transmit (TX) path 154. The RF transceiver 150 may include analog and digital reception components including amplifiers (e.g., Low Noise Amplifiers (LNAs)), Power Amplifiers (PAs), filters, RF demodulators (e.g., RF IQ demodulators)), and analog-to-digital converters (ADCs), which RF transceiver 150 may utilize to convert radio frequency signals to digital baseband samples. In the receive (RX) path 152, the RF transceiver 150 may be configured to receive analog radio frequency signals from the antenna system 142 and perform analog and digital RF front-end processing on the analog radio frequency signals to produce digital baseband samples (e.g., In-Phase/Quadrature (IQ) samples). In the transmit (TX) path 154, the RF transceiver 150 may be configured to receive digital baseband samples from the processing system 146 (e.g., from a baseband modem 156 of the processing system 146) and perform analog and digital RF front-end processing on the digital baseband samples to produce analog radio frequency signals to provide to the antenna system 142 for wireless transmission. The RF transceiver 150 may thus also include analog and digital transmission components, which RF transceiver 150 may utilize to mix the digital baseband samples received from the processing system 146 and produce the analog radio frequency signals for wireless transmission by the antenna system 142.

The processing system 146 may be configured for transmission and reception processing. The processing system 146 may include, for example, a baseband modem 156 (e.g., including a digital signal processor 158 and a protocol controller 160), an application processor 162, a memory 164, and a power supply 166. The baseband modem 156 may be configured to direct the communication functionality of wireless communication device 102 according to the communication protocols associated with each (radio) access network, and may be configured to execute control over antenna system 142 and RF transceiver 154 to transmit and receive radio signals according to the formatting and scheduling parameters defined by each communication protocol.

The baseband modem 156 may include a digital signal processor 158, which may be configured to perform physical layer (PHY, Layer 1) transmission and reception processing to, in the transmit path 154, prepare outgoing transmit data that the protocol controller 160 provides for transmission via RF transceiver 150, and, in the receive path 152, prepare incoming received data that the RF transceiver 150 provides for processing by the protocol controller 160. Digital signal processor 158 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancellation, and any other physical layer processing functions.

The wireless communication device 102 may be configured to operate according to one or more radio communication technologies, and the digital signal processor 158 may be responsible for lower-layer processing functions (e.g., PHY, Layer 1) of the radio communication technologies, while the protocol controller 160 may be responsible for upper-layer protocol stack functions (e.g., Data Link Layer/Layer 2 and/or Network Layer/Layer 3). Protocol controller 160 may thus be responsible for controlling the radio communication components of wireless communication device 102 (antenna system 142, RF transceiver 150, and digital signal processor 158) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 160 may be configured to perform both user-plane and control-plane functions to facilitate the transfer of application layer data to and from radio wireless communication device 102 according to the specific protocols of the supported radio communication technology. User-plane functions may include header compression and encapsulation, security, error checking and correction, channel multiplexing, scheduling and priority, while control-plane functions may include setup and maintenance of radio bearers.

In an exemplary configuration, wireless communication device 102 may be configured to transmit and receive data according to multiple radio communication technologies. Accordingly, one or more of antenna system 142, RF transceiver 150, digital signal processor 158, and/or protocol controller 160 may include separate components or instances dedicated to different radio communication technologies and/or unified components that are shared between different radio communication technologies. Accordingly, while antenna system 142, RF transceiver 150, digital signal processor 158, and protocol controller 160 are shown as individual components in FIG. 1B, it is understood that they may encompass separate components dedicated to different radio communication technologies.

The processing system 146 may further include an application processor 162 (e.g., a CPU) and a memory 164. Application processor 162 may be configured to handle the layers above the protocol stack, including the transport and application layers. Application processor 162 may be configured to execute various applications and/or programs of wireless communication device 102 at an application layer of wireless communication device 102, such as an operating system (OS), a user interface (UI) for supporting user interaction, and/or various user applications. The application processor 162 may interface with baseband modem 156 and act as a source (in the transmit path) and a sink (in the receive path) for user data, such as voice data, audio/video/image data, messaging data, application data, basic Internet/web access data, etc. Memory 164 may embody a memory component of wireless communication device 102, such as a hard drive or another such permanent memory device. Although not explicitly depicted in FIG. 1B, the various other components of wireless communication device 102 may additionally each include integrated permanent and/or non-permanent memory components, such as for storing software program code, buffering data, etc.

FIG. 1C shows a network access node 104 in a schematic representation according to the present disclosure. As an exemplary application scenario, a network access node 104 may be configured to provide LTE and/or 5G radio services. In general, the network access node 104 may include an antenna system 172 (also referred to herein as antenna circuitry), transceiver system 174 (also referred to herein as transceiver circuitry), and a baseband system 176 (e.g., including a physical layer processor 178 and a protocol controller 180)

In an abridged overview of the operation of network access node 104, network access node 104 may be configured to transmit and receive radio frequency signals via antenna system 172, which may be an antenna array including multiple antennas. Radio transceiver 174 may be configured to perform transmit and receive RF processing to convert outgoing baseband samples from baseband subsystem 176 into analog radio signals to provide to antenna system 172 for radio transmission, and may be configured to convert incoming analog radio signals received from antenna system 172 into baseband samples to provide to baseband subsystem 176. Physical layer processor 178 may be configured to perform transmit and receive PHY processing on baseband samples received from radio transceiver 174 to provide to controller 180, and may be configured to perform transmit and receive PHY processing on baseband samples received from controller 180 to provide to radio transceiver 174. Controller 180 may be configured to control the communication functionality of network access node 104 according to the corresponding radio communication technology protocols, which may include exercising control over antenna system 172, radio transceiver 174, and physical layer processor 178.

In an exemplary configuration, the network access node 104 may be configured to serve one or more wireless communication devices using beamforming techniques and/or coordinated spatial techniques, e.g. may be configured to transmit a beamformed signal to a wireless communication device in one or more directions.

Network access node 104 may thus be configured to provide the functionality of network access nodes in wireless networks by providing an access network to enable served wireless communication devices to access communication data. For example, network access node 104 may also interface with a core network, one or more other network access nodes, or various other data networks and servers via a wired or wireless backhaul interface.

In the newer generations of wireless networks, the network access nodes 104 no longer emit signals in an omnidirectional manner as in older generations of wireless networks. A network access node 104 may rather emit signal using multiple beams, each emitted towards a respective direction. A wireless communication device 102 may thus connect with a network access node 104 via the strongest beam for that wireless communication device 102. Illustratively, depending on the location of the wireless communication device 102 and on its relative position with respect to the network access node 104, one of the beams may provide the strongest signal transmission and reception among the plurality of beams.

In general, the basic concepts of the establishment of a connection between a wireless communication device 102 and a network access node 104 are known in the art. A brief description is provided herein to introduce aspects relevant for the present disclosure. As an abridged overview, the network access node 104 may transmit a single sideband modulation (SSB) signal on all beams at different time instances. The wireless communication device 102 may identify the beam with the strongest signal power by measuring the SSB signal on all beams.

After having identified the carrier frequency and the timing of the SSB signal, the wireless communication device 102 may decode the SSB signal with the strongest signal power. The SSB signal includes information to assist the wireless communication device 102 in carrying out a PRACH procedure to connect with the network node 104. For example, the SSB signal may include information about a start time of a PRACH procedure for the wireless communication device 102, e.g. in terms of a time offset with respect to the reception of the SSB signal at which the wireless communication device 102 should transmit a PRACH signal.

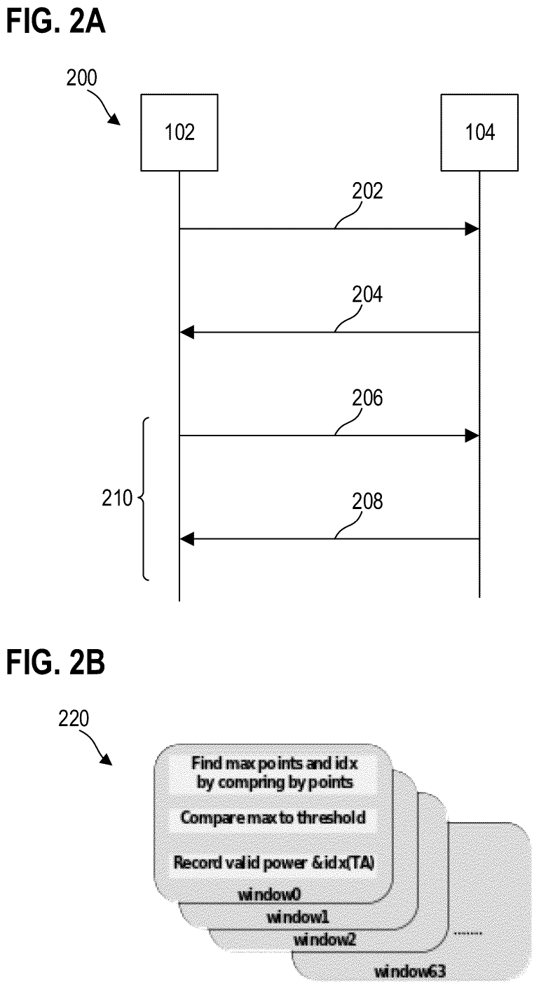

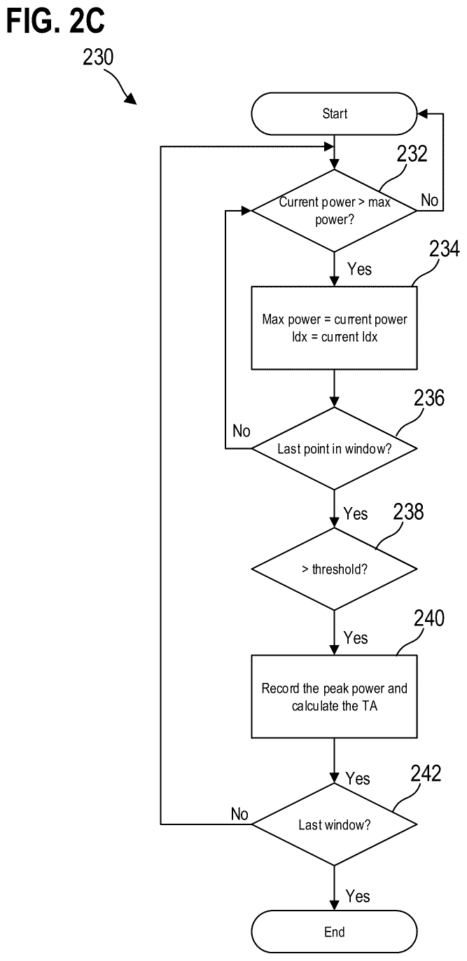

In this regard, FIG. 2A shows a communication diagram related to a PRACH procedure 200 between a wireless communication device 102 and a network node 104. In brief, the wireless communication device 102 may transmit a PRACH message 202 (a PRACH preamble) to the network node 104. The wireless communication device 102 may generate the PRACH message 202 using a root sequence. For example, the PRACH message 202 may be or include a Zadoff-Chu sequence. In general, the wireless communication device 102 may select at random one Zadoff-Chu sequence from a plurality of predefined Zadoff-Chu sequences (e.g., 64 predefined Zadoff-Chu sequences), and transmit the selected Zadoff-Chu sequence as PRACH message 202. A PRACH message may also be referred to as Message 1.

In this context, the network node 104 is not aware of the timing of the reception of the PRACH message 202, because such timing depends on the distance between the wireless communication device 102 and the network node 104, and may thus vary based on the location of the wireless communication device 102. In general, however, the network node 104 may carry out PRACH detection based on a known time window within which all PRACH receptions may occur based on a maximum range of the network node 104 (e.g., a maximum cell range).

Within the time window, the network node 104 may receive noise when no PRACH message 202 is received. To detect reception of a (valid) PRACH signal 202, the network node 104 may carry out a correlation within the time window for each possible root sequence with which a wireless communication device 102 may have generated a PRACH message 202. Considering the scenario with 64 Zadoff-Chu sequences, the network node 104 may carry out a correlation for each of the 64 Zadoff-Chu sequences, thus carrying out PRACH detection in 64 detection windows, as shown in FIG. 2B for a plurality of detection windows 220.

For each root sequence (e.g., each Zadoff-Chu sequence), the network node 104 may correlate the root sequence with the received signal for all possible time shifts within the time window. The correlation output may be low for all time shifts if the detection window corresponding to the root sequence under consideration includes (only) noise, and the correlation output may be high if the detection window corresponding to the root sequence under consideration includes a PRACH message corresponding to that root sequence. The high correlation output further indicates the time shift corresponding to the reception of the PRACH message. Considering Zadoff-Chu sequences, this type of detection is enabled by the low cross-correlation among different Zadoff-Chu sequences, and strong auto-correlation when timings are aligned (while having an ideally zero auto-correlation for time shifts that do not align the root sequence with the sequence included in received signal).

Thus, the network node 104 may determine that a PRACH message 202 was received and the time of reception based on the peak of the correlation output. The network device 104 thus verifies the presence of a PRACH preamble for each window by comparing every sample with a predefined detection threshold for the correlation output.

In this regard, FIG. 2C shows a schematic flow diagram of PRACH detection 230. The PRACH detection 230 may consider each sample within a detection window (illustratively, each sample of the received signal). In 232, the method 230 may determine whether the (correlation) power of the current sample is greater than the maximum recorded power for the current detection window. If yes, the method 230 may proceed to 234 and record the power of the current sample as maximum power and the index of the current sample as current index. The method 230 may carry out this evaluation for all the data points in the window (236), thus obtaining the maximum power within the detection window. The method 230 may then proceed to 238 to determine whether the determined maximum power is greater than a predefined threshold. If yes, the method 230 may proceed to 240 and record the peak power and calculate a timing advance (TA) for the wireless communication device 102, as discussed in further detail below. The method 230 may carry out the peak detection until the last window has been evaluated (242).

In general, the network node 104 wishes to receive uplink signals from all the wireless communication devices 102 connected to the network node 104 at the beginning of a time slot. Thus, after having identified the time-position of the PRACH message 202 (e.g., with the method in FIG. 2C), the network node 104 may instruct the wireless communication device 102 to prepone its transmission by sending to the wireless communication device 102 a timing advance command, as part of a response message 204. A response message may also be referred to as Message 2.

The wireless communication device 102 may receive the response message 204, and adjust the timing of a future transmission to the network node 104 according to the timing advance included in the response message 204. The wireless communication device 102 may acknowledge the receipt of the response message 204 and of the timing advance by sending a connection request 206 (e.g., a RRC connection request) to the network node 104. A connection request may also be referred to as Message 3.

In this context, it may happen that another wireless communication device 102 carries out the same procedure at the same time, and it may happen that both wireless communication devices 102 select at random the same root sequence for the PRACH signal 202. Thus, the PRACH procedure 200 may include a collision resolution mechanism 210. To avoid collision, each wireless communication device 102 may generate a random number as a temporary identifier and include the generated random number in the connection request. For example, the random number may be referred to as Temporary C-RNTI or TC-RNTI, where C-RNTI stands for Cell Radio Network Temporary Identifier. Different wireless communication devices 102 generate different random numbers, at least with a very high probability.

The network node 104 may select the connection request 206 from the wireless communication devices 102 having the strongest power. The network node 104 may copy the temporary identifier included in the selected connection request into a contention resolution message 208 (e.g., as C-RNTI). Both wireless communication devices 102 receive the contention resolution message 208, and compare the temporary identifier in the contention resolution message 208 with the own temporary identifier. The wireless communication device 102 for which the temporary identifiers coincide may determine that the PRACH procedure was successful, whereas the wireless communication device 102 for which the temporary identifiers do not coincide may determine that the PRACH attempt failed. A contention resolution message may also be referred to as Message 4.

A PRACH procedure 200 may allow a wireless communication device 102 to establish an initial connection with a network node 104, or may also serve other purposes, such as handover. The specific content of the various messages exchanged between the wireless communication device 102 and the network node 104 may vary depending on the scenario for which the PRACH procedure 200 is utilized, as generally known in the art.

The present disclosure may be related to an adapted approach for PRACH detection that may provide a reduced processing time compared to a conventional approach in presence of noise (e.g., compared to the process flow in FIG. 2C). In the present disclosure, PRACH detection is described from the standpoint of a network access node (e.g., a base station, eNB for 4G, gNB for 5G and beyond). It is however understood that also other entities of a wireless network may be responsible for PRACH detection, and the aspects described in relation to PRACH detection at a network access node may apply in a corresponding manner to PRACH detection at other entities in a wireless network.

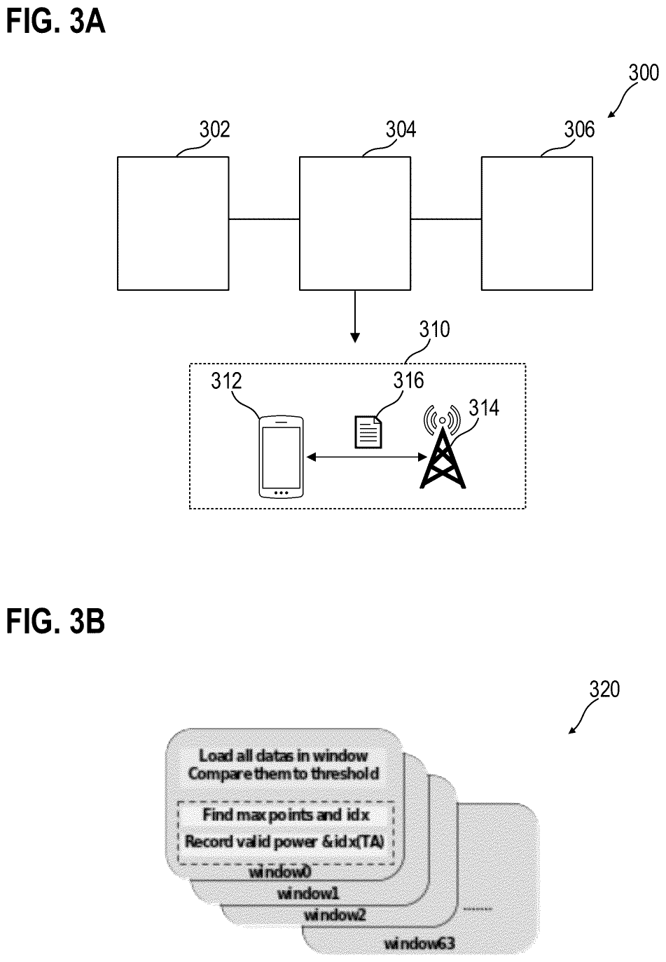

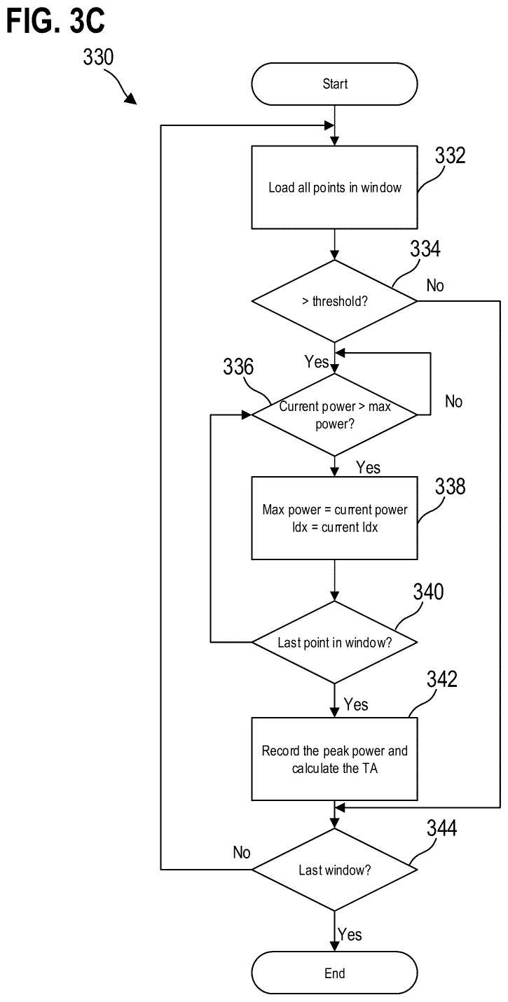

FIG. 3A shows a device 300 for use in a wireless network (e.g., in the wireless network 100) in a schematic representation according to the present disclosure. The device 300 may be configured to perform adapted PRACH detection in the wireless network. The device 300 may be configured to be deployed at various locations within the wireless network. As an example, a network access node (e.g., the network access node 104 described in relation to FIG. 1A) may include the device 300. For example, a base station (e.g., eNodeB, gNodeB) may include the device 300. It is however understood that also other entities within a wireless network may include a device configured to perform PRACH detection as described herein, e.g. a core network node (e.g., a network controller) may include the device 300, as another example. It is also understood that the operation of the device 300 (e.g., of a processor 304 of the device 300) may be distributed among more than one network entity, e.g. among a plurality of entities (e.g., nodes and/or units) present in the wireless network and/or communicatively coupled with the wireless network (e.g., in a cloud-environment). As an exemplary configuration, the device 300 may be a module or a node for deployment in a wireless network. It is understood that the representation of the device 300 may be simplified for the purpose of illustration, and the device 300 may include additional components with respect to those shown.

The device 300 may include a communication interface 302, a processor 304, and a memory 306. The memory 306 may be communicatively coupled with the processor 304, and may be configured to store instructions (e.g., software instructions, program code) executed by the processor 304. The instructions may cause the processor 304 to perform an adapted method 310 for PRACH detection, described in further detail below. It is understood that aspects described with respect to a configuration of the processor 304 may also apply to the method 310, and vice versa. The method 310 may be a computer-implemented method.

It is also understood that the operations caused by the instructions stored in the memory 306 may be implemented as a configuration of the processor 304, and vice versa. Illustratively, the processor 304 may be configured to carry out various functions described in relation to the instructions stored in the memory 306. In a corresponding manner, a functionality carried out by the processor 304 may correspond to a respective step of the method 310, and a step of the method 310 may correspond to a respective configuration of the processor 304 to carry out a functionality resulting in the method step.

It is also understood that the processor 304 may include a single processor (e.g., a single circuit) configured to carry out the method 310, or may include a plurality of processors (sub-processors, or sub-circuits) each configured to carry out a portion of the method 310. For example, a first (sub-)processor may carry out a first function related to the method 310, a second (sub-)processor may carry out a second function related to the method 310, etc. The various (sub-)processors may be communicatively coupled with one another, e.g. over a network.

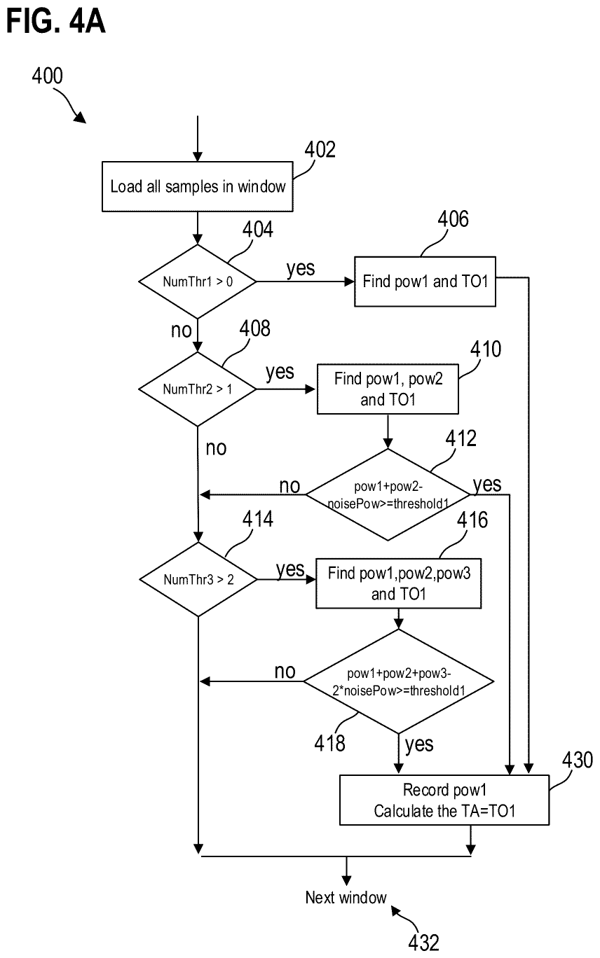

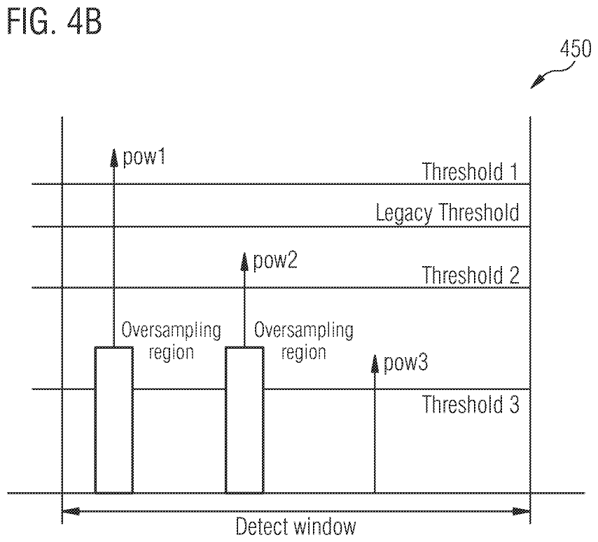

The PRACH detection proposed herein may be based on two parts. A first part (see FIG. 3C) includes an adjustment of the order of finding the maximum value and comparing the data with the threshold compared to the legacy PRACH detection of FIG. 2C. A second part (see FIG. 4A), which may be carried out in addition or in alternative to the first part, includes the use of a plurality of thresholds to evaluate the data within a detection window. For example, the PRACH detection may be part of a PRACH procedure to allow a wireless communication device 312 to establish a connection with a network access node 314, or part of a PRACH procedure for any other purpose. For the sake of brevity the network access node 314 may be referred to in the following simply as network node 314.

In general, the PRACH detection may be carried out in a plurality of detection windows 320, shown in FIG. 3B. In principle, any suitable number of detection windows 320 may be considered. In a preferred configuration the method 310 may include carrying out PRACH detection in 64 detection windows 320. It is however understood that the 310 may include carrying out PRACH detection in any suitable number of detection windows, e.g. a number in the range from 2 to 200, for example in the range from 5 to 150, for example in the range from 10 to 100.

A detection window 320 may be a time window associated with a root sequence for the generation of a PRACH message (a PRACH preamble). Illustratively, as discussed in relation to FIG. 2A to FIG. 2C, a wireless communication device 312 may generate a PRACH message 316 using a root sequence, e.g. selecting at random a root sequence from a plurality of predefined root sequences. As an example, the wireless communication device 312 may generate a PRACH message by selecting at random a Zadoff-Chu sequence from a plurality of predefined Zadoff-Chu sequences, e.g. 64 predefined Zadoff-Chu sequences. A PRACH message may also be referred to herein as PRACH signal, or PRACH preamble.

A detection window 320 may thus be or include a time window including possible reception times of a PRACH message at the network node 314. A time window may cover a time range from an initial time point (time zero) corresponding to the shortest possible reception time of a PRACH message at the network node 314 (e.g., after the network node 314 transmitted a SSB signal), to a final time point corresponding to the longest possible reception time of a PRACH message at the network node 314. The duration (in other words, the length) of a detection window 320 may vary depending on the overall configuration and capabilities of the network node 314, e.g. depending on a range in which the network node 314 may transmit and receive messages.

A detection window 320 may include a signal representing the signal that the network node 314 receives during the corresponding time window. Each detection window 320 may thus include a plurality of samples. Each sample may correspond to a respective time point within the time window, and may represent the received signal at that time point. In some aspects, the processor 304 may carry out a transformation of the signal received at the network node 314 from a representation in the frequency domain to a representation in the time domain to define a detection window 320, e.g. the processor 304 may carry out an Inverse Fast Fourier Transform of the signal received at the network node 314 to define a time representation of the signal of a detection window 320 from the frequency spectrum of the signal.

The PRACH detection may be based on evaluating the power of the signal received at the network node 314, illustratively the power of each sample of a detection window 320 (for each detection window). In this regard, the signal power may be expressed and processed in any suitable manner. In a preferred configuration, the signal power may be expressed as correlation power. Illustratively, the processor 304 may carry out a correlation of the signal received at the network node 314 within a detection window to provide (e.g., generate, calculate) a corresponding correlation signal for that detection window 320. In this case, each sample of the detection window 320 may be representative of a result of the correlation at the respective time point.

In particular, each detection window 320 may be associated with a corresponding root sequence of the plurality of predefined root sequences, and may include a signal representative of a correlation between the signal received at the network node 314 (within the time window) and the respective root sequence. For example, the processor 304 may be configured to define the plurality of detection windows 320 by providing a time window including (covering) reception times of a PRACH message at the network node 314, and carrying out a correlation of a signal received at the network node 314 during the time window with each of the plurality of predefined root sequences. In this regard, each sample of a detection window 320 may be representative of a correlation power at the respective time point, illustratively the sample may represent a magnitude or amplitude of a correlation between the signal received at the network node 314 and the root sequence associated with the detection window 320 at the time point corresponding to the sample.

A first detection window may thus be associated with a first root sequence and include the correlation of the first root sequence with the received signal, a second detection window may be associated with a second root sequence and include the correlation of the second root sequence with the received signal, etc. Illustratively, the processor 304 may defined a detection windows 320 based on the correlation output (illustratively, a result of the correlation) of a correlation operation between the signal received at the network access node 314 and the respective root sequence (e.g., Zadoff-Chu sequence) associated with that window. A correlation operation may be particularly advantageous in view of the cross-correlation and auto-correlation properties of the root sequences used for generating PRACH messages, but it is understood that in principle also other types of processing may be provided.

In this context, each detection window 320 may thus include a plurality of samples, each corresponding to a respective time point within the time window, and indicating the correlation power at that time point. The correlation power may illustratively represent a magnitude (an amplitude) of the correlation output. As discussed in relation to FIG. 2A to FIG. 2C, the predefined root sequences for generating a PRACH message may have cross-correlation and auto-correlation properties that ensure that the output of the correlation will be low if the detection window includes noise (or PRACH messages generated using other root sequences) and will be high if the detection window includes a PRACH message generated using the root sequence associated with the detection window. Illustratively, the correlation power will be high in correspondence of the sample at the time point at which the PRACH message is received at the network node 314.

The processor 304 may carry out the correlation operation in any suitable manner known in the art. By way of illustration, the processor 304 may shift a signal representing the root sequence by a plurality of time shifts to cover the detection window from the initial time point to the final time point, and evaluate a matching between the signal representing the root sequence and the signal received at the network node 314 for each of the plurality of time shifts.

In the following, particular reference may be made to a “correlation power” and to a comparison between a “correlation power” and corresponding threshold(s). It is however understood that the aspects described in relation to a “correlation power” may apply in a corresponding manner to other types of representation of the signal received at the network node 314. It is also understood that aspects described in relation to a “power” and a “threshold power” may apply to a “correlation power” and a “threshold correlation power”, and vice versa.

Part 1 of the adapted PRACH detection method 310 will be described with reference to the flow diagram 330 in FIG. 3C. As shown, the method 310 may start and may include, in 332, loading all points in a detection window. Illustratively the method 310 may include obtaining (and considering) the power value of each sample within the detection window, e.g. the correlation powers of all the samples within the detection window.

In general, the method 310 may include comparing a power value of each sample in a detection window with a predefined threshold power, and after having carried out the comparison determining (e.g., deciding) whether to search for the sample with the maximum power within the detection window based on a result of the comparison.

In this regard, the method 310 may include, in 334, determining whether at least one of the power values of the samples within the detection window 320 is greater than a predefined threshold power. Considering the “correlation scenario”, the method 310 may include determining whether at least one of the correlation powers is greater than a predefined threshold correlation power (illustratively, a predefined threshold for the correlation output).

As a difference with the legacy PRACH detection, the proposed approach may thus include comparing all data in the window with the threshold first, prior to carrying out the search for the maximum power (e.g., the maximum correlation power). If the powers (e.g., correlation powers) of the samples within the detection window 320 are all less than the threshold, the processor 304 may determine (e.g., establish) that there is no valid PRACH signal in the detection window 320, and there is no need to perform the operation of finding the maximum value and recording the position. In this case, the method 310 may proceed further to 344 and carry out the PRACH detection in the next detection window, or terminate the PRACH detection if all windows have been analyzed.

If at least one sample has a power greater than the predefined threshold power (e.g., at least one sample has a correlation power greater than the predefined threshold correlation power). The method 310 may include finding the maximum in the same manner as in legacy PRACH. Illustratively, the method 310 may include scanning through the samples, and for each sample determining whether the power of the sample is greater than the current maximum power (336) and, if yes, record the power of the sample as current maximum power and the index of the sample as current index (338). Considering the “correlation scenario”, the method 310 may include scanning through the samples, and for each sample determining whether the correlation power of the sample is greater than the current maximum correlation power (336) and, if yes, recording the power of the sample as current maximum power and the index of the sample as current index (338).

The index of a sample may represent the position of the sample within the detection window 320. Illustratively, the index of a sample may represent the time location of the sample in the detection window. An index may represent the position of the sample in any suitable manner, for example an index may be an integer number. Only as an example, the initial time point of the detection window may have index 0, and the indices may increase by an integer unit (1) until the final time point of the detection window.

When the last point in the window is reached (340), the method 310 may proceed to 342 and record the peak power identified as maximum power for the detection window (e.g., the peak correlation power), and calculate the timing advance for the (future) communication between the wireless communication device 312 and the network node 314. Illustratively, if the power (e.g., correlation power) of at least one sample exceeds the threshold, the method 310 may identify a valid PRACH request from a user, otherwise no valid PRACH requests are identified within the detection window 320.

The method 310 may include calculating the timing advance based on the index of the sample having the greatest power (e.g., the greatest correlation power) among the plurality of samples. As mentioned, the timing advance may enable a synchronization of the communication between the network node 314 and the wireless communication device 312, to ensure that the network node 314 receives uplink transmission from all connected user devices in a synchronized manner. The method 310 may thus include calculating the timing advance to compensate for a propagation delay between the wireless communication device 312 and the network node 314, and to cause a synchronization of the uplink timing of a communication between the wireless communication device 312 to the network node 314.

In case of positive detection of a valid PRACH request, the method 310 may include reporting the recorded power, index, and calculated timing advance to the higher layer. The method 310 may further include informing the user that the PRACH request is successful, e.g. by causing the network node 314 to send a response message (Message 2) to the wireless communication device 312. For example, the method 310 may further include transmitting the calculated timing advance to the user.

In some aspects, the processor 304 may include dedicated portions (e.g., dedicated circuits) to carry out the various parts of the method 310. For example, the processor 304 may include a comparator portion (e.g., a comparator circuit) configured to compare the power of all the samples with the threshold power. The processor 304 may further include a search portion (e.g., a search circuit) configured to find the sample having the maximum power within the detection window. The processor 304 may further include a recording portion (e.g., a recording circuit) configured to record the peak power of the sample and the corresponding index. The processor 304 may further include a communication portion (e.g., a communication circuit) configured to transmit the signal representative of the successful PRACH detection.

In the proposed method, although the step of comparing with the threshold requires more operations than before (previously only comparing the maximum value with the threshold, now all numbers in the window are be compared with the threshold), due to the characteristics of the PRACH received signal, this operation may reduce operations of finding the maximum value and recording the position, thus saving computational resources.

In the legacy approach, the status of the (e.g., 64) detection windows is consistent, and the operations within each window are identical. They all identify the maximum value and its position within the window, compare the maximum value with the threshold, and determine whether it is a valid signal, as discussed in relation to FIG. 2C. On the other hand, the proposed method 310 includes comparing the data in the window to the threshold (first). If all data in the window is less than the threshold, it is considered unnecessary to further search for the maximum value and its position in the window. The status of the (e.g., 64) detection windows is consistent, and the operations within each window are identical. Detect maximum and maximum positions only when there is data that exceed the threshold in the window.

In addition or in alternative to adjusting the order of finding the maximum power within a detection window 320, the approach proposed herein may include a multi-threshold detection. The second part may be based on the realization that there could be more than one viable communication path between the wireless communication device 312 and the network node 314, so that the network node 314 may receive PRACH messages via a plurality of communication paths, and may communicate with the wireless communication device via the plurality of communication paths. In this scenario, evaluating a single threshold for a single path may pose a requirement that is excessively strict for certain scenarios, in which a single path communication is not viable, but a multi-path communication could be possible. The proposed approach considering multiple paths may thus reduce missed detection in a multi-path environment. A “missed detection” may include a scenario in which the wireless communication device 312 transmits a valid PRACH message, but the PRACH detection fails to detect the valid PRACH message.

In part 2, the method may include comparing the correlation power of the samples of a detection window with a plurality of threshold powers. The plurality of threshold powers may be ordered according to a decreasing power value. Considering the “correlation scenario”, the plurality of threshold powers may be a plurality of threshold correlation powers, each corresponding to a respective correlation power, and may be ordered according to a decreasing correlation power value.

For example, a first threshold power may have a first power value, and the first power value may be the greatest power value among the threshold powers (e.g., the greatest correlation power). A second threshold power may have a second power value, and the second power value may be less than the first power value, e.g. the second power value may be the second greatest power value among the threshold powers (e.g., the second greatest correlation power). A third threshold power may have a third power value, and the third power value may be less than the second power value, e.g. the third power value may be the third greatest power value among the threshold powers (e.g., the third greatest correlation power), etc.

The threshold powers may be defined based on a target probability of false alarm. For PRACH detection, the proposed method may include setting a target false alarm probability P_{fa}^{target} first, then calculating the false alarm probability on each sample P_{fa}^{sample}, and deducing the threshold.

For the legacy method

$${P}_{fa}^{sample} \approx \frac{{P}_{fa}^{target}}{{N}_{win} \cdot {L}_{win}}$$

and the deduced threshold is defined as Threshold_{legacy}, where N_{win} is the number of detection windows (e.g., 64, for example for 3GPP), and L_{win} is the length of a detection window (illustratively, the number of samples in a window). Considering the case in which only the strongest path is used in the PRACH detection, then

$${P}_{fa , 1 path}^{sample} \approx \frac{{P}_{fa , 1 path}^{target}}{{N}_{win} \cdot {L}_{win}} ,$$

where P_{fa,1 path}^{sample} is the target probability of false alarm when only considering one peak path.

Turning to the case in which a plurality of paths is considered, e.g. the two strongest paths, then

$${P}_{fa , 2 path}^{sample} \approx \sqrt{\frac{2 \cdot {P}_{fa , 2 path}^{target}}{{N}_{win} \cdot {L}_{win} \cdot ( {L}_{win} - 1 )}} ,$$

where P_{fa,2 path}^{sample} is the target probability of false alarm when considering two peak paths.

In case the three strongest paths in detection are considered, then

$${P}_{fa , 3 path}^{sample} \approx \sqrt[3]{\frac{6 \cdot {P}_{fa , 3 path}^{target}}{{N}_{win} \cdot {L}_{win} \cdot ( {L}_{win} - 1 ) \cdot ( {L}_{win} - 2 )}} ,$$

where P_{fa,3 path}^{sample} is the target probability of false alarm when considering three peak paths.

It may be assumed that P_{fa,1 path}^{sample}<P_{fa,2 path}^{sample}<P_{fa,3 path}^{sample}, so that Threshold₁>Threshold₂>Threshold₃, where Thresholdᵢ is the detection threshold for using the “i” strongest paths. The gap between Threshold₁ and Threshold₂ and/or Threshold₃ is the gain that the proposed approach may achieve.

It is understood that more than three paths may be considered, although increasing the number of paths may lead to a decrease in gain and an increase in complexity. Thus in the following the cases with two or three paths are considered, but it is understood that the aspects described may be extended to scenarios with more than three paths.

To keep the probability of false alarm close to legacy method, the following probabilities may be set P_{fa,1 path}^{target}=k₁*P_{fa}^{target}, P_{fa,2 path}^{target}=k₂*P_{fa}^{target}, and P_{fa,3 path}^{target}=k₃*P_{fa}^{target}, where 0<k₁, k₂, k₃<1, and k₁+k₂+k₃=1. Thus, the final probability of false alarm may be expressed as P_{fa}≤P_{fa,1 path}^{target}+P_{fa,2 path}^{target}+P_{fa,3 path}^{target}=P_{fa}^{target}.

It may be assumed that P_{fa,1 path}^{target}<P_{fa}^{target}, so that Threshold₁>Threshold_{legacy}, indicating that in single path channel the legacy method may facilitate the PRACH detection. In some aspects, the PRACH detection proposed herein may be combined with a legacy PRACH detection (e.g., as described in FIG. 2C), and the device 300 may carry out the adapted PRACH detection after a failed detection of any valid PRACH using the legacy PRACH detection.

Considering the graph 450 in FIG. 4B, the power of the first, second, and third strongest paths may be indicated as pow1, pow2, pow3, and their position as TO1, TO2, TO3 (indicating a respective time offset within the detection window). Illustratively, the index of a sample may represent a time offset with respect to the initial time point of the detection window. It is worth noting that if the Inverse Fast Fourier Transform (IFFT) in PRACH is oversampling, the oversampling region around pow1 and pow2 may be excluded (as shown in FIG. 4B). The number of samples having power exceeding Threshold_{legacy}, Threshold₁, Threshold₂, and Threshold₃ may be indicated as Num_{ThrLeg}, Num_{Thr1}, Num_{Thr2}, and Num_{Thr3}, respectively.

The multi-threshold PRACH detection will be described with reference to the flow diagram 400 in FIG. 4A. The steps of the method 400 may be part of the method 310 (e.g., as steps 334 to 342), or may be part of a legacy PRACH detection to replace the search for a maximum. As an abridged overview, the method 400 may include using the power (e.g., the correlation power) not only of the strongest path but also the power on other weaker paths, and combining together the power of the weaker paths for PRACH detection.

The method 400 may have two possible architectures for PRACH detection in each search window, referred to herein as architecture A and architecture B. According to architecture A, the method 400 may include, in 402, loading all power values in the current detection window (also referred to herein as search window). Illustratively, the method 400 may include determining the power values (e.g., the correlation power values) of all the samples within the detection window currently being evaluated.

The method 400 may further include, in 404, comparing the power values of all the samples with the first threshold power, illustratively with the threshold power having the greatest power value. Considering the correlation scenario, the method 400 may include comparing the correlation power values of all the samples with the first threshold correlation power. If at least one sample has a (correlation) power greater than the first threshold power, i.e. Num_{Thr1}>0, the method 400 may proceed to 406 and may include finding the power pow1 and the index (e.g., the time offset TO1) of the sample having power greater than the first threshold power. The method 400 may further proceed to 430 and may include recording the power of the identified sample, reporting the preamble index, and calculating the timing advance for the wireless communication device before moving to the next window (432).

If none of the samples has power greater than the first threshold power, the method 400 may proceed instead to 408, and may include comparing the power values of all the samples with the second threshold power, illustratively with the threshold power having the second greatest power value. Considering the correlation scenario, the method 400 may include comparing the correlation power values of all the samples with the second threshold correlation power. If at least two samples have a (correlation) power greater than the second threshold power, i.e. Num_{Thr2}>1, the method 400 may proceed to 410 and may include finding the powers pow1, pow2 and the indexes (the time offsets TO1, TO2) of the samples having power greater than the second threshold power. The method 400 may further proceed to 412 and may include determining whether the sum of the powers of the samples having power greater than the second threshold power is greater than the first threshold power. In this case, the method 400 may also include subtracting a noise power from the sum of the powers before evaluating whether the result is greater than the first threshold power. If yes, the method 400 may proceed to 430 and may include recording the powers of the identified samples and calculating the timing advance for the wireless communication device before moving to the next window (432). Illustratively, in this case the PRACH detection may be considered successful by considering that the plurality of paths, in combination, provide sufficient power (exceeding the first threshold power), e.g. sufficient correlation power. In this scenario, for a successful PRACH detection the method 400 may include instructing a (future) communication between the wireless communication device and the network node using the plurality of available communication paths (corresponding to the identified samples). Illustratively, the method 400 may include causing the wireless communication device and the network node to communicate with one another using the identified communication paths that provide sufficient power. For example, the method 400 may include defining a beamforming configuration for a communication between the wireless communication device and the network access node based on the identified communication paths, and causing the wireless communication device and the network access node to communicate with one another according to the defined beamforming configuration. The beamforming configuration may illustratively specify the directionality of the transmission/reception of messages between the wireless communication device and the network access node to communicate via the identified communication paths.

If less than two of the samples have power greater than the second threshold power, or if the sum of the powers of the samples having power greater than the second threshold power is less than the first threshold power, the method 400 may proceed to 414. In 414, the method 400 may include comparing the power values of all the samples with the third threshold power, illustratively with the threshold power having the third greatest power value. Considering the correlation scenario, the method 400 may include comparing the correlation power values of all the samples with the third threshold correlation power. If at least three samples have a (correlation) power greater than the third threshold power, i.e. Num_{Thr3}>2, the method 400 may proceed to 416 and may include finding the powers pow1, pow2, pow3 and the indexes (the time offsets TO1, TO2, TO3) of the samples having power greater than the third threshold power. The method 400 may further proceed to 418 and may include determining whether the sum of the powers of the samples having power greater than the third threshold power is greater than the first threshold power. In this case, the method 400 may also include subtracting a noise power (e.g., multiplied by two compared to the case of the second threshold power) from the sum of the powers before evaluating whether the result is greater than the first threshold power. If yes, the method 400 may proceed to 430 and may include recording the powers of the identified samples and calculating the timing advance for the wireless communication device before moving to the next window (432). Also in this scenario, for a successful PRACH detection the method 400 may include instructing a (future) communication between the wireless communication device and the network node using the plurality of available communication paths (corresponding to the identified samples).

If less than three of the samples have power greater than the third threshold power, or if the sum of the powers of the samples having power greater than the third threshold power is less than the first threshold power, the method 400 may either consider a fourth threshold power (not shown), or may move to the next window (432), indicating that no PRACH message was detected in the current detection window. The method 400 may loop to the next window until all windows are checked.

The Architecture B is similar with Architecture A, the only difference is the use of Num_{ThrLeg} instead of Num_{Thr1} in 404. Illustratively, in this case the first threshold power may be the legacy threshold power of legacy PRACH detection. Compared with Architecture A, Architecture B may have better performance of miss detection in single path channel, but worse performance of false alarm.

The number of threshold powers considered for the PRACH detection, and the relative difference among threshold powers may be adapted depending on system considerations. Illustratively, greater threshold powers may ensure a more robust communication, but may also lead to fewer successful PRACH detections. In a corresponding manner, a great relative difference between consecutive threshold powers may ensure covering more communication paths. Only as a numerical example, considering a reference threshold power, the first threshold power may correspond to the reference threshold power, the second threshold power may be in the range from 60% to 90% of the reference threshold power, the third threshold power may be in the range from 30% to 60% (excluded) of the reference threshold power, etc.

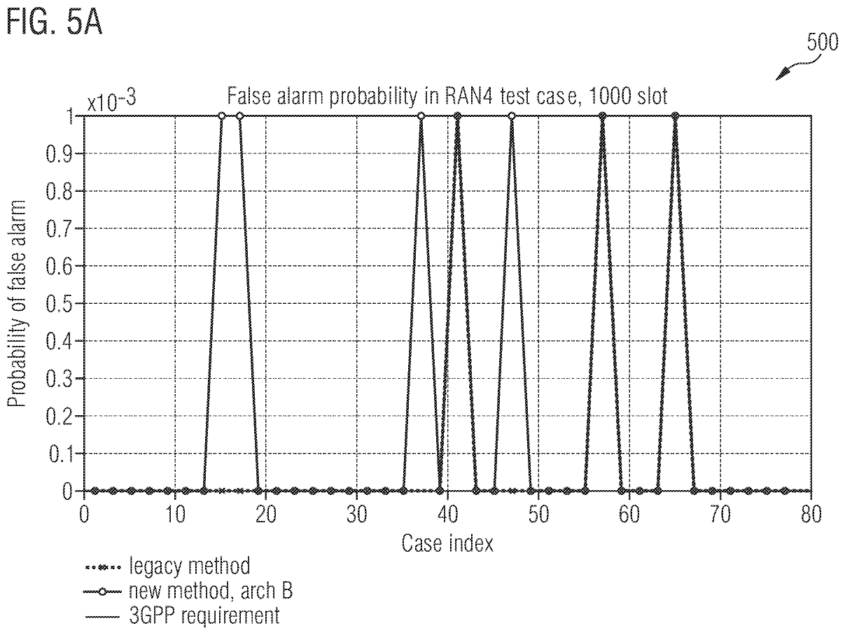

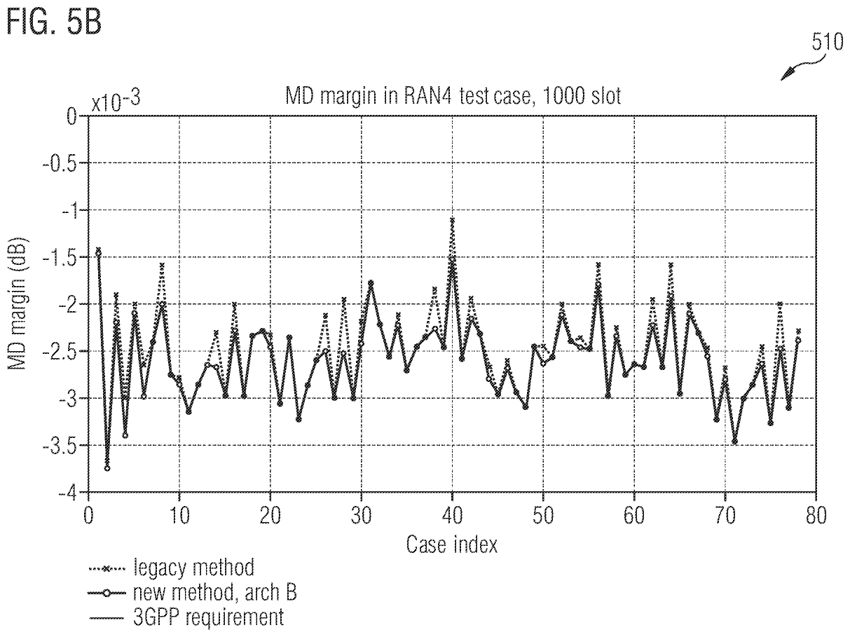

FIG. 5A and FIG. 5B show graphs 500, 510 illustrating simulation results for a comparison between the PRACH detection of the present disclosure and legacy PRACH detection. The graphs 500, 510 refer to 78 testcases defined in 3GPP 38.104 using architecture B defined above in relation to FIG. 4A and FIG. 4B. The results show a gain in miss detection margin and a slight loss in false alarm compared with legacy method.

In the following, various examples are provided that refer to the device 300, and methods 310, 330, 400.

Example 1 is a device for use in a wireless network, the device including: a processor; and a memory configured to store instructions. The instructions, when executed by the processor, cause the processor to: carry out a Physical Random Access Channel, PRACH, detection for detecting a reception at a network access node of a PRACH message from a wireless communication device. The PRACH detection includes, for each detection window of a plurality of detection windows, each including a plurality of samples: comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

In Example 2, the device according to example 1 may optionally further include that each detection window is a time window including possible reception times of a PRACH message at a network access node; and the plurality of samples of a detection window are representative of signal received at the network access node at different time points within the time window.

In Example 3, the device according to example 1 or 2 may optionally further include that each detection window is associated with a respective root sequence of a plurality of predefined root sequences for generating a PRACH message.

In Example 4, the device according to example 3 may optionally further include that the instructions further cause the processor to define the plurality of detection windows by carrying out a correlation of a signal received at a network access node during a time window with each of the plurality of predefined root sequences.

In Example 5, the device according to example 4 may optionally further include that the plurality of samples of a detection window are representative of a correlation output (e.g., a correlation power) of the correlation of the received signal with the root sequence associated with the detection window.

In Example 6, the device according to example 4 or 5 may optionally further include that the plurality of predefined root sequences include a plurality of predefined Zadoff-Chu sequences.

In Example 7, the device according to any one of examples 1 to 6 may optionally further include that the instructions further cause the processor to, in case of successful PRACH detection, calculate a timing advance for a communication between the wireless communication device and the network access node, based on the position of the identified sample within the detection window; and cause a transmission of the calculated timing advance to the wireless communication device.

In Example 8, the device according to any one of examples 1 to 7 may optionally further include that the predefined threshold power include a plurality of threshold powers, the plurality of threshold powers including a first threshold power and a second threshold power, the first threshold power having a greater power value compared to the second threshold power, and that the PRACH detection includes, for each detection window: comparing the power value of each sample of the plurality of samples with the first threshold power; and if the power value of at least one sample is greater than the first threshold power, identifying the sample having the power value greater than the first threshold power, and generating a result signal indicative of a successful PRACH detection and of a position of the identified sample within the detection window; if all the samples of the plurality of samples have a power value less than the first threshold power, comparing the power value of each sample of the plurality of samples with the second threshold power, and if the power value of at least two samples are greater than the second threshold power, identifying the samples having the power value greater than the second threshold power, and generating a result signal indicative of a successful PRACH detection and of a position of the identified samples within the detection window.

In Example 9, the device according to example 8 may optionally further include that the plurality of threshold powers further include a third threshold power, that the third threshold power has a lower power value compared to the second threshold power, and that the PRACH detection further includes, for each detection window: if all the samples of the plurality of samples have a power value less than the second threshold power, comparing the power value of each sample of the plurality of samples with the third threshold power, and if the power value of at least three samples are greater than the third threshold power, identifying the samples having the power value greater than the third threshold power, and generating a result signal indicative of a successful PRACH detection and of a position of the identified samples within the detection window.

In Example 10, the device according to example 8 or 9 may optionally further include that the identified samples within the detection window correspond to different communication paths between the wireless communication device and the network node; and the instructions further cause the processor to instruct a communication between the wireless communication device and the network node via the communication paths corresponding to the identified samples.

Example 11 is an apparatus for use in a wireless network, the apparatus including processing means for carrying out a Physical Random Access Channel, PRACH, detection for detecting a reception at a network access node of a PRACH message from a wireless communication device. The PRACH detection includes, for each detection window of a plurality of detection windows, each including a plurality of samples: comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

In Example 12, the apparatus according to example 11 may optionally further include any feature of examples 2 to 10, adapted accordingly.

Example 13 is a device for use in a wireless network, the device including: a processor configured to carry out a Physical Random Access Channel, PRACH, detection for detecting a reception at a network access node of a PRACH message from a wireless communication device. The PRACH detection includes, for each detection window of a plurality of detection windows, each including a plurality of samples: comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

In Example 14, the device according to example 13 may optionally further include any feature of examples 2 to 10, adapted accordingly.

Example 15 is a method of PRACH detection for detecting a reception at a network access node of a PRACH message from a wireless communication device, the method including: for each detection window of a plurality of detection windows, with each detection window including a plurality of samples, comparing a power value of each sample of the plurality of samples with a predefined threshold power; and after having carried out the comparison for all the samples of the plurality of samples: if the power value of at least one sample is greater than the predefined threshold power, identifying the sample having the greatest power value among the plurality of samples, and generating a result signal indicative of a successful PRACH detection and of a position of the identified sample within the detection window; if all the samples of the plurality of samples have a power value less than the predefined threshold power, refraining from searching for the sample having the greatest power value among the plurality of samples.

In Example 16, the method according to example 15 may optionally further include that each detection window is a time window including possible reception times of a PRACH message at a network access node; and that the plurality of samples of a detection window are representative of signal received at the network access node at different time points within the time window.

In Example 17, the method according to example 15 or 16 may optionally further include that each detection window is associated with a respective root sequence of a plurality of predefined root sequences for generating a PRACH message.

In Example 18, the method according to example 17 may optionally further include that defining the plurality of detection windows by carrying out a correlation of a signal received at a network access node during a time window with each of the plurality of predefined root sequences.

In Example 19, the method according to example 18 may optionally further include that the plurality of samples of a detection window are representative of a correlation output of the correlation of the received signal with the root sequence associated with the detection window.

In Example 20, the method according to example 18 or 19 may optionally further include that the plurality of predefined root sequences include a plurality of predefined Zadoff-Chu sequences.

In Example 21, the method according to any one of examples 15 to 20 may optionally further include, in case of successful PRACH detection, calculating a timing advance for a communication between the wireless communication device and the network access node, based on the position of the identified sample within the detection window; and causing a transmission of the calculated timing advance to the wireless communication device.

In Example 22, the method according to any one of examples 15 to 21 may optionally further include that the predefined threshold power includes a plurality of threshold powers, the plurality of threshold powers including a first threshold power and a second threshold power. The first threshold power has a greater power value compared to the second threshold power. The PRACH detection includes, for each detection window: comparing the power value of each sample of the plurality of samples with the first threshold power; and if the power value of at least one sample is greater than the first threshold power, identifying the sample having the power value greater than the first threshold power, and generating a result signal indicative of a successful PRACH detection and of a position of the identified sample within the detection window; if all the samples of the plurality of samples have a power value less than the first threshold power, comparing the power value of each sample of the plurality of samples with the second threshold power, and if the power value of at least two samples are greater than the second threshold power, identifying the samples having the power value greater than the second threshold power, and generating a result signal indicative of a successful PRACH detection and of a position of the identified samples within the detection window.

In Example 23, the method according to example 22 may optionally further include that the plurality of threshold powers further include a third threshold power. The third threshold power has a lower power value compared to the second threshold power. The PRACH detection further includes, for each detection window: if all the samples of the plurality of samples have a power value less than the second threshold power, comparing the power value of each sample of the plurality of samples with the third threshold power, and if the power value of at least three samples are greater than the third threshold power, identifying the samples having the power value greater than the third threshold power, and generating a result signal indicative of a successful PRACH detection and of a position of the identified samples within the detection window.

In Example 24, the method according to example 22 or 24 may optionally further include that the identified samples within the detection window correspond to different communication paths between the wireless communication device and the network node; and the method further includes instructing a communication between the wireless communication device and the network node via the communication paths corresponding to the identified samples.

Example 25 is a non-transitory computer readable medium including instructions which, when the instructions are executed by a computer, cause the computer to carry out the method of any one of examples 15 to 24.

Example 26 is a computer program product including instructions which, when the program is executed by a computer, cause the computer to carry out the method of any one of examples 15 to 24.

Example 27 is a device for use in a wireless network, the device including: a processor; and a memory configured to store instructions, wherein the instructions, when executed by the processor, cause the processor to: carry out a Physical Random Access Channel, PRACH, detection for detecting a reception at a network access node of a PRACH message from a wireless communication device, wherein the PRACH detection includes, for each detection window of a plurality of detection windows, each including a plurality of samples: comparing a power value of each sample of the plurality of samples with a predefined threshold power; and after having carried out the comparing for all the samples of the plurality of samples, determining whether to carry out a search for a maximum power within the detection window based on a result of the comparison.

In Example 28, the device according to example 27 may optionally further include that determining whether to carry out the search for the maximum power within the detection window based on the result of the comparing includes: determining that the power value of at least one sample is greater than the predefined threshold power, and identifying the sample having the greatest power value among the plurality of samples, and generating a result signal indicative of a successful PRACH detection and of a position of the identified sample within the detection window.

In Example 28, the device according to example 27 may optionally further include that determining whether to carry out the search for the maximum power within the detection window based on the result of the comparing further includes: determining that all the samples of the plurality of samples have a respective power value less than the predefined threshold power, and refraining from searching for the sample having the greatest power value among the plurality of samples.

In Example 29, the device of any one of examples 26 to 28 may optionally further include any feature of examples 1 to 10, adapted accordingly.

Example 30 is a method of PRACH detection for detecting a reception at a network access node of a PRACH message from a wireless communication device, the method including, for each detection window of a plurality of detection windows, with each detection window including a plurality of samples: comparing a power value of each sample of the plurality of samples with a predefined threshold power; and after having carried out the comparing for all the samples of the plurality of samples, determining whether to carry out a search for a maximum power within the detection window based on a result of the comparison.

In Example 31, the method according to example 30 may optionally further include that determining whether to carry out the search for the maximum power within the detection window based on the result of the comparing includes: determining that the power value of at least one sample is greater than the predefined threshold power, and identifying the sample having the greatest power value among the plurality of samples, and generating a result signal indicative of a successful PRACH detection and of a position of the identified sample within the detection window.

In Example 32, the method according to example 31 may optionally further include that determining whether to carry out the search for the maximum power within the detection window based on the result of the comparing further includes: determining that all the samples of the plurality of samples have a respective power value less than the predefined threshold power, and refraining from searching for the sample having the greatest power value among the plurality of samples.

In Example 33, the method of any one of examples 30 to 32 may optionally further include any feature of examples 15 to 24, adapted accordingly.

The term “data” as used herein, for example in relation to “input data” or “output data”, may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as used herein may be understood as any kind of technological entity that allows handling of data. The data may be handled according to one or more specific functions that the processor may execute. Further, a processor as used herein may be understood as any kind of circuit, e.g., any kind of analog or digital circuit. A processor may thus be or include an analog circuit, digital circuit, mixed-signal circuit, logic circuit (e.g., a hard-wired logic circuit or a programmable logic circuit), microprocessor (for example a Complex Instruction Set Computer (CISC) processor or a Reduced Instruction Set Computer (RISC) processor), Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. A “processor” may also be a logic-implementing entity executing software, for example any kind of computer program, for example a computer program using a virtual machine code such as for example Java. A “processor” as used herein may also include any kind of cloud-based processing system that allows handling of data in a distributed manner, e.g. with a plurality of logic-implementing entities communicatively coupled with one another (e.g. over the internet) and each assigned to handling the data or part of the data. By way of illustration, an application running on a server and the server can also be a “processor”. Any other kind of implementation of the respective functions, which will be described below in further detail, may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The term “system” detailed herein may be understood as a set of interacting elements, the elements may be, by way of example and not of limitation, one or more physical components (e.g., processors, transmitters and/or receivers) and/or one or more digital components (e.g., code segments, instructions, protocols). Generally, the system may include one or more functions to be operated (also referred to as “operating functions”) of which each may be controlled for operating the whole system.

The term “memory” as used herein may be understood as a computer-readable medium (e.g., a non-transitory computer-readable medium), in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Furthermore, it is appreciated that registers, shift registers, processor registers, data buffers, among others, are also embraced herein by the term memory. It is also appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “software” refers to any type of executable instruction, including firmware.

As used herein, a “cell” in the context of telecommunications may be understood as a sector served by a network access node. A wireless network may be distributed over a plurality of cells. Accordingly, a cell may be a set of geographically co-located antennas that correspond to a particular sector of a network access node. A network access node can thus serve one or more cells (or sectors), where the cells are characterized by distinct communication channels. Furthermore, the term “cell” may be utilized to refer to any of a macro cell, micro cell, femto cell, pico cell, etc. An “inter-cell handover” may be understood as a handover from a first “cell” to a second “cell”, where the first “cell” is different from the second “cell”. “Inter-cell handovers” may be characterized as either “inter-network access node handovers” or “intra-network access node handovers”. “Inter-network access node handovers” may be understood as a handover from a first “cell” to a second “cell”, where the first “cell” is provided at a first network access node and the second “cell” is provided at a second, different, network access node. “Intra-network access node handovers” may be understood as a handover from a first “cell” to a second “cell”, where the first “cell” is provided at the same network access node as the second “cell”. A “serving cell” may be understood as a “cell” that a wireless communication device is currently connected to according to the mobile communications protocols of the associated mobile communications network standard. In case a cell is served by a mobile network access node, the cell itself may be non-stationary, e.g. may be a mobile cell.

The present disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the examples described herein. For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Exemplary Cellular Wide Area radio communication technologies that the present disclosure may utilize include, but are not limited to: Long Term Evolution (LTE), Long Term Evolution-Advanced (LTE-A), 5th Generation (5G) communication systems, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSDPA Plus (HSDPA+), HSUPA (High-Speed Uplink Packet Access), HSUPA Plus (HSUPA+), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Zigbee, Bluetooth®, Wireless Gigabit Alliance (WiGig) standard, Worldwide Interoperability for Microwave Access (WiMax) (e.g., according to an IEEE 802.16 radio communication standard, e.g., WiMax fixed or WiMax mobile), mmWave standards in general (wireless systems operating at 10-90 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication arrangements such as Intelligent-Transport-Systems, etc. Cellular Wide Area radio communication technologies also include “small cells” of such technologies, such as microcells, femtocells, and picocells. Cellular Wide Area radio communication technologies may be generally referred to herein as “cellular” communication technologies. As used herein, a first radio communication technology may be different from a second radio communication technology if the first and second radio communication technologies are based on different communication standards.

The term “5G” as used herein refers to wireless technologies as provided by the 3GPP and International Telecommunication Union (ITU) standards. This may include spectral use overlapping with the existing LTE frequency range (e.g., 600 MHz to 6 GHz) and also include spectral use in the millimeter wave bands (e.g., 24-86 GHz). Also, the terms 5G, New Radio (NR), or 5G NR may be used interchangeably. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum.

The present disclosure may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, aspects described herein can also employ radio communication technologies on a secondary basis on bands such as the TV White Space bands (typically below 790 MHz) where in particular the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, aspects described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. Aspects described herein can also use radio communication technologies with different Single Carrier or OFDM flavors (CP-OFDM, SC-FDMA, SC-OFDM, filter bank-based multicarrier (FBMC), OFDMA, etc.) and in particular 3GPP NR (New Radio), which can include allocating the OFDM carrier data bit vectors to the corresponding symbol resources.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor may transmit or receive data over a software-level connection with another processor in the form of radio signals, where radio-layer components carry out the physical transmission and reception, such as radio frequency (RF) transceivers and antennas, and the processors perform the logical transmission and reception over the software-level connection.

The term “communicate” encompasses one or both of transmitting and receiving, i.e., unidirectional or bidirectional communication in one or both of the incoming and outgoing directions. In general, the term “communicate” may include the exchange of data, e.g., unidirectional or bidirectional exchange in one or both of the incoming and outgoing directions.

The term “calculate” encompasses both ‘direct’ calculations via a mathematical expression/formula/relationship and ‘indirect’ calculations via lookup or hash tables and other array indexing or searching operations.

As utilized herein, the term “derived from” designates being obtained directly or indirectly from a specific source. Accordingly, data derived from a source includes data obtained directly from the source or indirectly from the source, i.e. through one or more secondary agents.

The word “exemplary” is used herein to mean “serving as an example, instance, or illustration”. Any embodiment or design described herein as “exemplary” is not necessarily to be construed as preferred or advantageous over other embodiments or designs.

The words “plural” and “multiple” in the description and the claims, if any, are used to expressly refer to a quantity greater than one. Accordingly, any phrases explicitly invoking the aforementioned words (e.g. “a plurality of [objects]”, “multiple [objects]”) referring to a quantity of objects is intended to expressly refer more than one of the said objects. For instance, the phrase “a plurality” may be understood to include a numerical quantity greater than or equal to two (e.g., two, three, four, five, [ . . . ], etc.). The terms “group”, “set”, “collection”, “series”, “sequence”, “grouping”, “selection”, etc., and the like in the description and in the claims, if any, are used to refer to a quantity equal to or greater than one, i.e. one or more. Accordingly, the phrases “a group of [objects]”, “a set of [objects]”, “a collection of [objects]”, “a series of [objects]”, “a sequence of [objects]”, “a grouping of [objects]”, “a selection of [objects]”, “[object] group”, “[object] set”, “[object] collection”, “[object] series”, “[object] sequence”, “[object] grouping”, “[object] selection”, etc., used herein in relation to a quantity of objects is intended to refer to a quantity of one or more of said objects. It is appreciated that unless directly referred to with an explicitly stated plural quantity (e.g. “two [objects]”, “three of the [objects]”, “ten or more [objects]”, “at least four [objects]”, etc.) or express use of the words “plural”, “multiple”, or similar phrases, references to quantities of objects are intended to refer to one or more of said objects.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

As used herein, a signal (e.g., data) that is “indicative of” a value or other information may be a digital or analog signal that encodes or otherwise communicates the value or other information in a manner that can be decoded by and/or cause a responsive action in a component receiving the signal. The signal may be stored or buffered in computer readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

Any vector and/or matrix notation utilized herein is exemplary in nature and is employed solely for purposes of explanation. Accordingly, aspects of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A device for use in a wireless network, the device comprising:
a processor; and
a memory configured to store instructions, wherein the instructions, when executed by the processor, cause the processor to:
carry out a Physical Random Access Channel, PRACH, detection for detecting a reception at a network access node of a PRACH message from a wireless communication device,
wherein the PRACH detection comprises, for each detection window of a plurality of detection windows, each comprising a plurality of samples:
comparing a power value of each sample of the plurality of samples with a predefined threshold power; and
after having carried out the comparing for all the samples of the plurality of samples:
if the power value of at least one sample is greater than the predefined threshold power, identifying the sample having the greatest power value among the plurality of samples, and generating a result signal indicative of a successful PRACH detection and of a position of the identified sample within the detection window; and
if all the samples of the plurality of samples have a respective power value less than the predefined threshold power, refraining from searching for the sample having the greatest power value among the plurality of samples.

2. The device according to claim 1,
wherein each detection window is a time window comprising possible reception times of a PRACH message at a network access node; and
wherein the plurality of samples of a detection window are representative of signal received at the network access node at different time points within the time window.

3. The device according to claim 1,
wherein each detection window is associated with a respective root sequence of a plurality of predefined root sequences for generating a PRACH message.

4. The device according to claim 3,
wherein the instructions further cause the processor to define the plurality of detection windows by carrying out a correlation of a signal received at the network access node during a time window with each of the plurality of predefined root sequences.

5. The device according to claim 4,
wherein the plurality of samples of a detection window are representative of a correlation output of the correlation of the signal received at the network access node with the respective root sequence associated with the detection window.

6. The device according to claim 3,
wherein the plurality of predefined root sequences comprise a plurality of predefined Zadoff-Chu sequences.

7. The device according to claim 1,
wherein the instructions further cause the processor to, in case of successful PRACH detection, calculate a timing advance for a communication between the wireless communication device and the network access node, based on the position of the identified sample within the detection window; and
cause a transmission of the calculated timing advance to the wireless communication device.

8. The device according to claim 1,
wherein the predefined threshold power comprises a plurality of threshold powers, the plurality of threshold powers comprising a first threshold power and a second threshold power, wherein the first threshold power has a greater power value compared to the second threshold power, and
wherein the PRACH detection comprises, for each detection window:
comparing the power value of each sample of the plurality of samples with the first threshold power; and if the power value of at least one sample is greater than the first threshold power, identifying the sample having the power value greater than the first threshold power, and generating the result signal indicative of successful PRACH detection and of the position of the identified sample within the detection window; and
if all the samples of the plurality of samples have the respective power value less than the first threshold power, comparing the power value of each sample of the plurality of samples with the second threshold power, and if the power value of at least two samples are greater than the second threshold power, identifying the samples having the power value greater than the second threshold power, and generating the result signal indicative of successful PRACH detection and of the position of the identified samples within the detection window.

9. The device according to claim 8,
wherein the plurality of threshold powers further comprise a third threshold power, wherein the third threshold power has a lower power value compared to the second threshold power,
wherein the PRACH detection further comprises, for each detection window:
if all the samples of the plurality of samples have the respective power value less than the second threshold power, comparing the power value of each sample of the plurality of samples with the third threshold power, and if the power value of at least three samples are greater than the third threshold power, identifying the samples having the power value greater than the third threshold power, and generating a result signal indicative of successful PRACH detection and of the position of the identified samples within the detection window.

10. The device according to claim 8,
wherein the identified samples within the detection window correspond to different communication paths between the wireless communication device and the network node; and wherein the instructions further cause the processor to instruct a communication between the wireless communication device and the network access node via the communication paths corresponding to the identified samples.

11. A method of PRACH detection for detecting a reception at a network access node of a PRACH message from a wireless communication device, the method comprising, for each detection window of a plurality of detection windows, with each detection window including a plurality of samples:
comparing a power value of each sample of the plurality of samples with a predefined threshold power; and
after having carried out the comparing for all the samples of the plurality of samples, determining whether to carry out a search for a maximum power within the detection window based on a result of the comparison.

12. The method according to claim 11,
wherein determining whether to carry out the search for the maximum power within the detection window based on the result of the comparing comprises:
determining that the power value of at least one sample is greater than the predefined threshold power, and
identifying the sample having the greatest power value among the plurality of samples, and generating a result signal indicative of a successful PRACH detection and of a position of the identified sample within the detection window.

13. The method according to claim 12,
wherein determining whether to carry out the search for the maximum power within the detection window based on the result of the comparing further comprises:
determining that all the samples of the plurality of samples have a respective power value less than the predefined threshold power, and
refraining from searching for the sample having the greatest power value among the plurality of samples.

14. The method according to claim 11,
wherein each detection window is a time window comprising possible reception times of a PRACH message at the network access node; and
wherein the plurality of samples of a detection window are representative of signal received at the network access node at different time points within the time window.

15. The method according to claim 11,
wherein each detection window is associated with a respective root sequence of a plurality of predefined root sequences for generating a PRACH message; and
wherein the method further comprises defining the plurality of detection windows by carrying out a correlation of a signal received at the network access node during a time window with each of the plurality of predefined root sequences.

16. The method according to claim 15,
wherein the plurality of samples of a detection window are representative of a correlation output of the correlation of the signal received at the network access node with the root sequence associated with the detection window.

17. The method according to claim 12,
wherein the method further comprises, in case of successful PRACH detection, calculating a timing advance for a communication between the wireless communication device and the network access node, based on the position of the identified sample within the detection window; and
causing a transmission of the calculated timing advance to the wireless communication device.

18. The method according to claim 11,
wherein the predefined threshold power comprises a plurality of threshold powers, the plurality of threshold powers comprising a first threshold power and a second threshold power, wherein the first threshold power has a greater power value compared to the second threshold power, and
wherein the PRACH detection comprises, for each detection window:
comparing the power value of each sample of the plurality of samples with the first threshold power; and if the power value of at least one sample is greater than the first threshold power, identifying the sample having the power value greater than the first threshold power, and generating a result signal indicative of successful PRACH detection and of the position of the identified sample within the detection window; and
if all the samples of the plurality of samples have the respective power value less than the first threshold power, comparing the power value of each sample of the plurality of samples with the second threshold power, and if the power value of at least two samples are greater than the second threshold power, identifying the samples having the power value greater than the second threshold power, and generating a result signal indicative of successful PRACH detection and of the position of the identified samples within the detection window.

19. The method according to claim 18,
wherein the plurality of threshold powers further comprise a third threshold power, wherein the third threshold power has a lower power value compared to the second threshold power,
wherein the PRACH detection further comprises, for each detection window:
if all the samples of the plurality of samples have the respective power value less than the second threshold power, comparing the power value of each sample of the plurality of samples with the third threshold power, and if the power value of at least three samples are greater than the third threshold power, identifying the samples having the power value greater than the third threshold power, and generating a result signal indicative of successful PRACH detection and of the position of the identified samples within the detection window.

20. The method according to claim 18,
wherein the identified samples within the detection window correspond to different communication paths between the wireless communication device and the network node; and wherein the method further comprises instructing a communication between the wireless communication device and the network access node via the communication paths corresponding to the identified samples.
